(19) United States
(12) Patent Application Publication
(10) Pub. No.: US 2014/0049484 A1
(43) Pub. Date: Feb. 20, 2014

(54) TOUCH PANEL AND METHOD FOR MANUFACTURING THE SAME

(71) Applicant: SAMSUNG ELECTRO-MECHANICS CO., LTD., Gyunggi-do (KR)

(72) Inventor: Seung Hyun Ra, Gyunggi-do (KR)

(73) Assignee: SAMSUNG ELECTRO-MECHANICS CO., LTD., Gyunggi-do (KR)

(21) Appl. No.: 13/658,693

(22) Filed: Oct. 23, 2012

(30) Foreign Application Priority Data
Aug. 20, 2012 (KR) 10-2012-0090733

(51) Int. Cl. G06F 3/041; H05B 33/10

(52) U.S. Cl. 345/173; 427/66

(57) ABSTRACT

Disclosed herein is a touch panel, including: a substrate; a black matrix formed on the substrate and defining a pixel area; a first electrode formed on the black matrix; a color filter layer formed in the pixel area on the substrate; and a second electrode formed on the color filter layer.

### CROSS REFERENCE TO RELATED APPLICATION

This application claims the benefit of Korean Patent Application No. 10-2012-0090733, filed on Aug, 20, 2012, entitled “Touch Panel and Method for Manufacturing the Same”, which is hereby incorporated by reference in its entirety into this application.

### BACKGROUND OF THE INVENTION

1. Technical Field

The present invention relates to a touch panel and a method for manufacturing the same.

2. Description of the Related Art

With development of a computer using a digital technology, auxiliary apparatuses of the computer have also been developed together, and personal computers, portable transmission apparatuses, other personal information apparatuses, and the like perform text and graphic processing by using various input devices such as a keyboard and a mouse.

However, with rapid progress of an information-oriented society, a purpose of the computer tends to be gradually extended, and as a result, it is difficult to efficiently drive a product only by using a keyboard and a mouse serving as current input devices. Accordingly, the necessity of an apparatus which is simple and less misoperated and in which anybody can easily input information has increased.

Further, the focus of a technology associated with the input devices has changed to high reliability, durability, innovation, design and processing associated technologies over a level to satisfy a general function and a touch panel (touch screen) is developed as the input devices which can input information such as texts, graphics, and the like in order to achieve the object.

The touch panel is a tool that is installed on a display surface of flat panel display devices such as an electronic notebook, a liquid crystal display device (LCD), a plasma display panel (PDP), electroluminescence (EL), and the like and an image display device such as a cathode ray tube (CRT) and used for a user to select desired information while viewing the image display device.

Types of the touch panel are classified into a resistive type, a capacitive type, an electromagnetic type, a surface acoustic wave type (SAW type), and an infrared type. These various types of touch panels are adopted in electronic products by considering a problem in signal amplification, a difference in resolution, a difficulty in design and processing technologies, an optical characteristic, an electrical characteristic, a mechanical characteristic, an environment-resistant characteristic, an input characteristic, and durability and economic efficiency, and types used in all of the fields include a resistive type touch panel and a capacitive type touch panel.

Meanwhile, in the touch panel in the related art, a sensing electrode is formed through indium tin oxide (ITO). However, in the case of ITO, indium having excellent electrical conductivity, which is a raw material is expensive as rare-earth metal and is expected to be exhausted within ten years from now, and as a result, demand and supply are not smooth.

For this reason, as disclosed in Korean Registration Patent No. 10-1111565, a research of forming an electrode using metal is in active progress. The electrode made of metal is more excellent than ITO in electrical conductivity, and demand and supply of metal are smooth. However, when the electrode of the touch panel is visually recognized or light is irradiated to the electrode from the outside, the electrode glitters, and as a result, visibility of the touch panel deteriorates.

Further, the structure of the touch panel in the related art is separately manufactured, such that the touch panel is generally attached to a front surface of the display device, for example, the liquid crystal display (LCD).

However, in this case, it is difficult to manufacture the apparatus adopting the touch panel to be thin and a process to separately produce the touch panel and assemble the touch panel to the liquid crystal display is carried out, and as a result, it is disadvantageous in terms of manufacturing convenience and manufacturing cost.

### SUMMARY OF THE INVENTION

The present invention has been made in an effort to provide a touch panel in which an electrode made of metal included in a touch panel structure is not externally and visually recognized, and a method for manufacturing the same.

Further, the present invention has been made in an effort to provide a touch panel integrated with a color filter substrate of a liquid crystal display for slimming of an apparatus adopting a touch panel structure, and a method for manufacturing the same.

According to a first preferred embodiment of the present invention, there is provided a touch panel, including: a substrate; a black matrix formed on the substrate and defining a pixel area; a first electrode formed on the black matrix; a color filter layer formed in the pixel area on the substrate; and a second electrode formed on the color filter layer.

The first electrode may be formed by a thin line.

The second electrode may be formed by a surface shape.

The first electrode may contain any one of copper (Cu), aluminum (Al), gold (Au), silver (Ag), titanium (Ti), palladium (Pd), and chrome (Cr).

The first electrode may be made of metallic silver formed by exposing/developing a silver salt emulsion layer.

The second electrode may be made of conductive polymer or metal oxide.

The second electrode may contain any one of poly-3,4-ethyleneoxytiophene/polystryelensulfonate (PEDOT/PSS), polyaniline, polyacetylene, and polyphenylvinylene.

The second electrode may contain indium-tin oxide.

The touch panel may further include an overcoat layer formed on the color filter layer, and the second electrode may be formed on the overcoat layer.

According to a second preferred embodiment of the present invention, there is provided a method for manufacturing a touch panel, including: (a) preparing a substrate; (b) forming a black matrix to define a pixel area on the substrate; (c) forming a first electrode on the black matrix; (d) forming a color filter layer formed in the pixel area on the substrate; and (e) forming a second electrode on the color filter layer.

In step (c), the first electrode may be formed by using metal containing any one of copper (Cu), aluminum (Al), gold (Au), silver (Ag), titanium (Ti), palladium (Pd), and chrome (Cr) through a plating or evaporation process.

In step (c), the first electrode may be formed by exposing/developing a silver salt emulsion layer.

In step (c), the first electrode may be formed by a thin line.

In step (e), the second electrode is formed by using conductive polymer containing any one of poly-3,4-ethyleneoxytiophene/polystryelensulfonate (PEDOT/PSS), polyaniline, polyacetylene, or polyphenylvinylene through a dry process, a wet process, or a direct patterning process.

In step (e), the second electrode may be formed by using metal oxide containing indium-tin oxide through the dry process, the wet process, or the direct patterning process.

In step (e), the second electrode may be formed by a surface shape.

The method may further include forming an overcoat layer on the color filter layer, after step (d).

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view illustrating a touch panel according to a preferred embodiment of the present invention;

FIG. 2 is a plan view of the touch panel illustrated in FIG. 1; and

FIGS. 3 through 7 are flowcharts of manufacturing the touch panel illustrated in FIG. 1.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

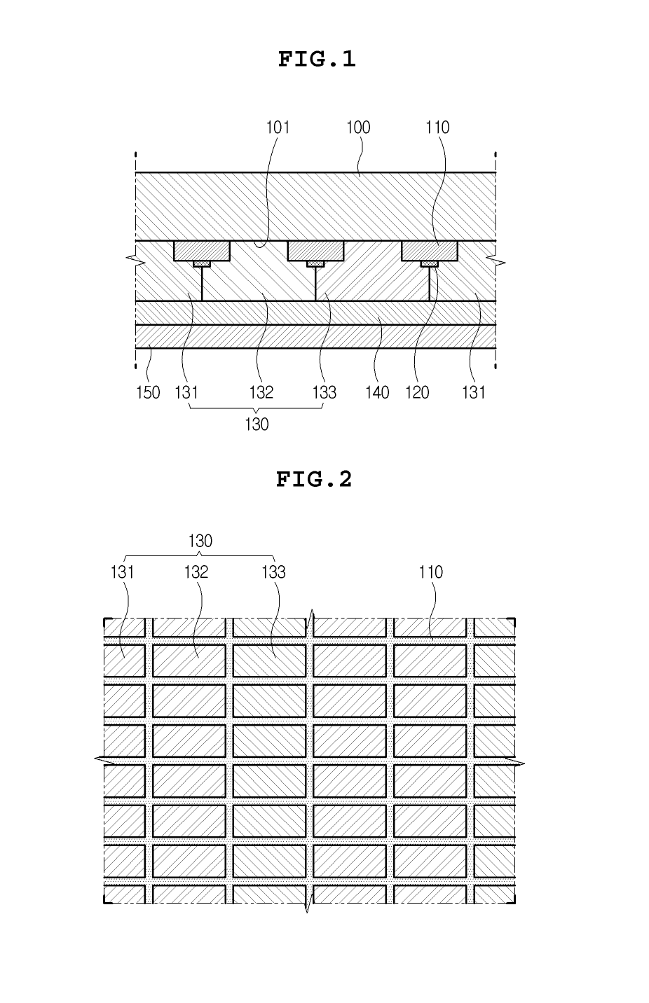

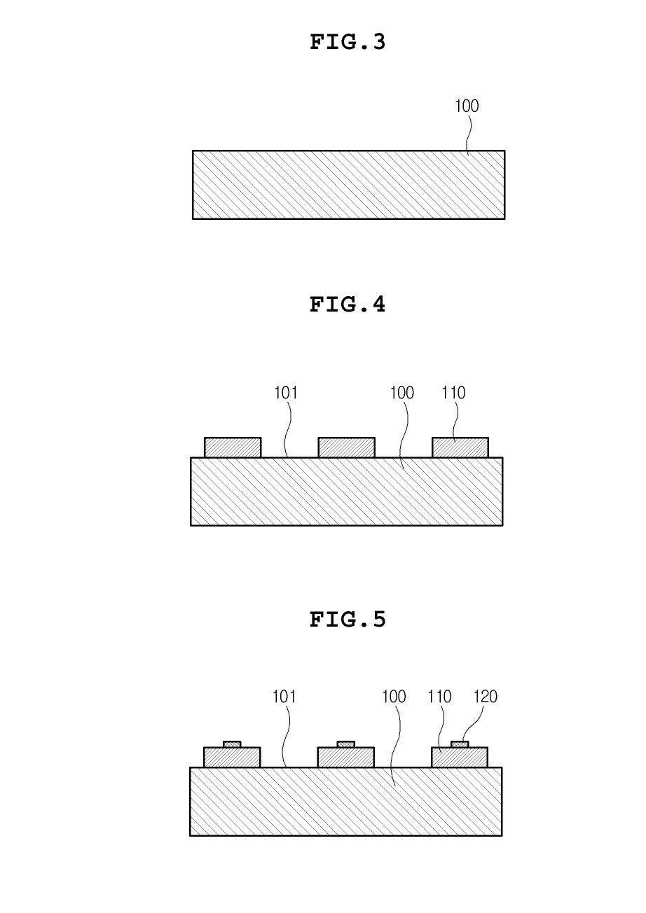

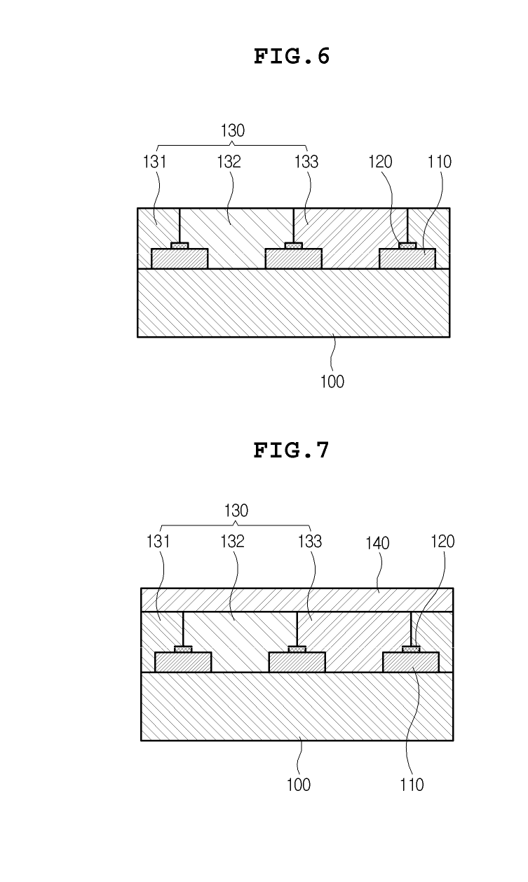

FIG. 1 is a cross-sectional view illustrating a touch panel according to a preferred embodiment of the present invention and FIG. 2 is a plan view of the touch panel illustrated in FIG. 1. FIGS. 3 through 7 are flowcharts of manufacturing the touch panel illustrated in FIG. 1.

The touch panel according to the preferred embodiment of the present invention includes a substrate 100, a black matrix 110 formed on the substrate 100 and defining a pixel area 101, a first electrode 120 formed on the black matrix 110, a color filter layer 130 formed in the pixel area 101 on the substrate 100, and a second electrode 150 formed on the color filter layer 130.

The touch panel according to the preferred embodiment is integrated with a color filter array in components of a liquid crystal display (not illustrated) including a thin-film transistor array, the color filter array, and liquid crystals filled between the arrays. Accordingly, the substrate 100 included in the preferred embodiment means a substrate 100 included in the color filter array.

The substrate 100 may be made of a transparent insulating material which may be transmitted by light, and as one detailed example, the substrate 100 may be made of a glass material.

The black matrix 110 is formed on the substrate 100 and defines the pixel area 101 on the substrate 100, and serves to prevent a light leakage phenomenon, and prevent optical interference among neighboring pixel areas 101.

When the first electrode 120 and the second electrode 150 are touched by a user, the first electrode 120 and the second electrode 150 generate signals to allow a controller (not illustrated) to recognize a touch coordinate.

The first electrode 120 is formed on the black matrix 110. In detail, the first electrode 120 may be made of any one selected from copper (Cu), aluminum (Al), gold (Au), silver (Ag), titanium (Ti), palladium (Pd), and chrome (Cr) or combinations thereof. The first electrode 120 is made of the materials and may be formed on the black matrix 110 through a plating process or an evaporation process. In this case, the first electrode 120 may be formed by a thin line having a minute linewidth due to a characteristic of the metal having excellent electrical conductivity. The first electrode 120 may be made of metallic silver formed by exposing/developing a silver salt emulsion layer in addition to the metal.

The second electrode 150 is formed on the color filter layer 130. The color filter layer 130 will be first described before describing the second electrode 150.

The color filter layer 130 as a general color filter layer included in the liquid crystal display may include subpixels 131, 132, and 133 implementing red (R), green (G), and blue (B) colors. The subpixels 131, 132, and 133 are formed in the pixel area 101 on the substrate 100 partitioned by the black matrix 110. In this case, the subpixels 131, 132, and 133 may be formed to cover the black matrix 110 and the first electrode 120.

The second electrode 150 may be directly formed on the color filter layer 130 formed as above or an overcoat layer 140 formed on the color filter layer 130.

The overcoat layer 140 forms a planarized surface on the color filter layer 130 and at the same time, serves to protect the color filter layer 130 from an external environment.

The second electrode 150 may be directly formed on the color filter layer 130 as described above or formed on the overcoat layer 140. The second electrode 150 may be made of any one selected from copper (Cu), aluminum (Al), gold (Au), silver (Ag), titanium (Ti), palladium (Pd), and chrome (Cr) or the combinations thereof similarly as the first electrode 120. Alternatively, the second electrode 150 may be made of the metallic silver formed by exposing/developing the silver salt emulsion layer.

Alternatively, the second electrode 150 may be made of conducive polymer or metal oxide.

Herein, the conductive polymer is excellent in flexibility and simple in coating process. The conductive polymer may contain poly-3,4-ethyleneoxytiophene/polystryelensulfonate (PEDOT/PSS), polyaniline, polyacetylene, or polyphenylvinylene.

The metal oxide may contain indium-tin oxide.

The second electrode 150 formed by using the conductive polymer or the metal oxide may be formed by a dry process, a wet process, or a direct patterning process. Herein, the dry process means sputtering, evaporation, and the like, the wet process means dip coating, spin coating, roll coating, spray coating, and the like, and the direct patterning process means screen printing, gravure printing, inkjet printing, and the like.

In this case, while the first electrode 120 is formed by the thin line, the second electrode 150 may be formed in a surface shape. When the second electrode 150 is formed in the surface shape, the second electrode 150 may effectively interfere noise generated from the liquid crystal display, and as a result, electro magnetic interference (EMI) may be prevented.

Meanwhile, since the first electrode 120 of the preferred embodiment is formed on the black matrix 110, the first electrode 120 is covered by the black matrix 110 not to be recognized externally as illustrated in FIG. 2. Accordingly, in the touch panel according to the preferred embodiment, a moire phenomenon may be prevented and visibility may be significantly improved.

Hereinafter, a method for manufacturing the touch panel according to a preferred embodiment will be described with reference to FIGS. 3 through 7, however, a content duplicated with the aforementioned content will be omitted.

Part 1 ends.

The method for manufacturing the touch panel according to the preferred embodiment includes (a) preparing a substrate 100, (b) forming a black matrix 110 to define a pixel area 101 on the substrate 100, (c) forming a first electrode 120 on the black matrix 110, (d) forming a color filter layer 130 in the pixel area 101 on the substrate 100, and (e) forming a second electrode 150 on the color filter layer 130.

In step (a), the substrate 100 is prepared as illustrated in FIG. 3. The substrate 100 as a substrate included in a color filter array may be made of a transparent insulating material as described above.

In step (b), the black matrix 110 is formed on the substrate 100 as illustrated in FIG. 4. The black matrix 110 may be formed on the substrate 100 through various known methods such as forming the black matrix 110 through a photolithography process after fully evaporating an organic material including for example, a black pigment on the substrate 100.

In step (c), the first electrode 120 is formed on the black matrix 110 as illustrated in FIG. 5. The first electrode 120 may be made of any one selected from copper (Cu), aluminum (Al), gold (Au), silver (Ag), titanium (Ti), palladium (Pd), and chrome (Cr) or combinations thereof. The first electrode 120 is made of the materials and may be formed on the black matrix 110 through a plating process or an evaporation process. In this case, the first electrode 120 may be formed by a thin line having a minute linewidth. The first electrode 120 may be made of metallic silver formed by exposing/developing a silver salt emulsion layer in addition to the metal.

In step (d), the color filter layer 130 is formed in the pixel area 101 on the substrate 100 as illustrated in FIG. 6. The color filter layer 130 may include red (R), green (G), and blue (B) subpixels 131, 132, and 133. The subpixels 131, 132, and 133 may be formed by exposing/developing red (R), green (G), and blue (B) photosensitizers to the pixel area 101 on the substrate 100 partitioned by the black matrix 110. In this case, the subpixels 131, 132, and 133 may formed to cover the black matrix 110 and the first electrode 120. The color filter layer 130 may be formed in various known methods in addition thereto.

In the method for manufacturing the touch panel according to the preferred embodiment, step (e) of forming the second electrode 150 directly on the color filter layer 130 may be performed after step (d). Alternatively, the method for manufacturing the touch panel according to the preferred embodiment may further include forming an overcoat layer 140 on the color filter layer 130 before step (e), after step (d).

The overcoat layer 140 forms a planarized surface on an exposed surface of the color filter layer 130 and at the same time, may serve to protect the color filter layer 130.

In step (e), the second electrode 150 may be formed on the color filter layer 130, alternatively, when the method for manufacturing the touch panel according to the preferred embodiment further includes forming the overcoat layer 140 as described above, the second electrode 150 may be formed on the overcoat layer 140 as illustrated in FIG. 7.

The second electrode 150 may be made of the same material as the first electrode 120 and alternatively, may be made of conductive polymer or metal oxide unlike the first electrode 120. When the second electrode 150 is made of the conductive polymer or the metal oxide, the second electrode 150 may be formed through the dry process, the wet process, or the direct patterning process, and in this case, the second electrode 150 may be formed by not the thin line but the surface shape.

According to the present invention, since a first electrode is covered by a black matrix, a moiré phenomenon can be prevented. Even when the first electrode is made of metal, the touch panel is not visually recognized externally and a mirror image phenomenon in the first electrode is also prevented, thereby significantly improving the visibility of the touch panel.

Moreover, since a second electrode is formed as a surface shape, and as a result, noise transferred from the liquid crystal display is effectively interrupted.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel, comprising:
a substrate;
a black matrix formed on the substrate and defining a pixel area;
a first electrode formed on the black matrix;
a color filter layer formed in the pixel area on the substrate; and
a second electrode formed on the color filter layer.

2. The touch panel as set forth in claim 1, wherein the first electrode is formed by a thin line.

3. The touch panel as set forth in claim 1, wherein the second electrode is formed by a surface shape.

4. The touch panel as set forth in claim 1, wherein the first electrode contains any one of copper (Cu), aluminum (Al), gold (Au), silver (Ag), titanium (Ti), palladium (Pd), and chrome (Cr).

5. The touch panel as set forth in claim 1, wherein the first electrode is made of metallic silver formed by exposing/developing a silver salt emulsion layer.

6. The touch panel as set forth in claim 1, wherein the second electrode is made of conductive polymer or metal oxide.

7. The touch panel as set forth in claim 1, wherein the second electrode contains any one of poly-3,4-ethyleneoxytiophene/polystryelensulfonate (PEDOT/PSS), polyaniline, polyacetylene, or polyphenylvinylene.

8. The touch panel as set forth in claim 1, wherein the second electrode contains indium-tin oxide.

9. The touch panel as set forth in claim 1, further comprising:
an overcoat layer formed on the color filter layer,
wherein the second electrode is formed on the overcoat layer.

10. A method for manufacturing a touch panel, comprising:
(a) preparing a substrate;
(b) forming a black matrix to define a pixel area on the substrate;
(c) forming a first electrode on the black matrix;
(d) forming a color filter layer formed in the pixel area on the substrate; and
(e) forming a second electrode on the color filter layer.

11. The method as set forth in claim 10, wherein in step (c), the first electrode is formed by using metal containing any one of copper (Cu), aluminum (Al), gold (Au), silver (Ag), titanium (Ti), palladium (Pd), and chrome (Cr) through a plating or evaporation process.

12. The method as set forth in claim 10, wherein in step (c), the first electrode is formed by exposing/developing a silver salt emulsion layer.

13. The method as set forth in claim 10, wherein in step (c), the first electrode is formed by a thin line.

14. The method as set forth in claim 10, wherein in step (e), the second electrode is formed by using conductive polymer containing any one of poly-3,4-ethyleneoxytiophene/polystryelensulfonate (PEDOT/PSS), polyaniline, polyacetylene, or polyphenylvinylene through a dry process, a wet process, or a direct patterning process.

15. The method as set forth in claim 10, wherein in step (e), the second electrode is formed by using metal oxide containing indium-tin oxide through the dry process, the wet process, or the direct patterning process.

16. The method as set forth in claim 10, wherein in step (e), the second electrode is formed by a surface shape.

17. The method as set forth in claim 10, further comprising:
forming an overcoat layer on the color filter layer, after step (d).
